(19) United States
(12) Patent Application Publication
(10) Pub. No.: US 2024/0363915 A1
(43) Pub. Date: Oct. 31, 2024

(54) Battery Pack And Cooling System

(71) Applicant: APPLE INC., Cupertino, CA (US)

(72) Inventors: Dylan Erb, San Jose, CA (US); Alexander Bartlett, San Jose, CA (US); Evan D. Maley, Redwood City, CA (US); Nivay Anandarajah, San Leandro, CA (US); Zhongying Shi, San Jose, CA (US)

(21) Appl. No.: 18/140,870

(22) Filed: Apr. 28, 2023

(51) Int. Cl. H01M 10/613; B60L 58/26; H01M 10/625; H01M 10/6556

(52) U.S. Cl. CPC H01M 10/613; B60L 58/26; H01M 10/625; H01M 10/6556; B60L 2240/545

(57) ABSTRACT

A system includes a battery pack having a first sub-pack and a second sub-pack, the first sub-pack having a first cell group and a second cell group, and the second sub-pack having a third cell group. A cooling system supplies a liquid coolant to a heat exchanger that is in thermal communication with the battery pack. A first section, a second section, and a third section of the heat exchanger are arranged sequentially in a flow direction of the liquid coolant between the coolant inlet and the coolant outlet, with the first section of positioned adjacent to the first cell group of the first sub-pack, the second section positioned adjacent to the third cell group of the second sub-pack, and the third section positioned adjacent to the second cell group of the first sub-pack.

### FIELD

The present disclosure relates generally to the field of battery packs and cooling systems for battery packs.

### BACKGROUND

Battery packs generate heat during charging and discharging. Some battery systems include liquid-cooled heat exchangers that are configured to absorb heat from the battery pack.

### SUMMARY

A first aspect of the disclosure is a system that includes a battery pack having a first sub-pack and a second sub-pack, the first sub-pack having a first cell group and a second cell group, and the second sub-pack having a third cell group. The system also includes a cooling system that is configured to supply a liquid coolant, and a heat exchanger that is in thermal communication with the battery pack, the heat exchanger including a coolant inlet, a coolant outlet, a first section, a second section, and a third section that are arranged sequentially in a flow direction of the liquid coolant between the coolant inlet and the coolant outlet. The first section of the heat exchanger is positioned adjacent to the first cell group of the first sub-pack, the second section of the heat exchanger is positioned adjacent to the third cell group of the second sub-pack, and the third section of the heat exchanger is positioned adjacent to the second cell group of the first sub-pack.

In some implementations, the system according to the first aspect of the disclosure includes a charging system that is configured to control charging of the first sub-pack and the second sub-pack independently. The charging system may be configured to control charging of the first sub-pack so that a temperature of the third cell group of the second sub-pack is lower than a temperature of the first cell group of the first sub-pack and lower than a temperature of the second cell group of the first sub-pack. In some implementations, during charging of the first sub-pack, the liquid coolant flows from the coolant inlet to the coolant outlet in the flow direction of the liquid coolant, the liquid coolant in the first section of the heat exchanger absorbs heat from the first cell group, the third cell group absorbs heat from the liquid coolant in the second section of the heat exchanger, and the liquid coolant in the third section of the heat exchanger absorbs heat from the second cell group. In some implementations, the charging system controls charging of the first sub-pack such that the second sub-pack is not charged during charging of the first sub-pack. In some implementations, the charging system controls charging of the first sub-pack such that the first sub-pack is charged at a first charging rate while the second sub-pack is charged at a second charging rate that is lower than the first charging rate.

In some implementations of the system according to the first aspect of the disclosure, the first cell group and the second cell group of the first sub-pack are electrically connected in series, and the second sub-pack is not directly electrically connected to the first sub-pack. In some implementations of the system according to the first aspect of the disclosure, the first sub-pack is configured to output electrical power at a first voltage, the second sub-pack is configured to output electrical power at a second voltage that is lower than the first voltage. In some implementations of the system according to the first aspect of the disclosure, the first cell group and the second cell group each include at least five times as many individual cells as the third cell group. In some implementations of the system according to the first aspect of the disclosure, the cooling system includes a refrigeration cycle thermal system that is configured to lower a temperature of the liquid coolant.

A second aspect of the disclosure is a system that includes a battery pack having a first sub-pack and a second sub-pack, the first sub-pack having a first cell group and a second cell group, and the second sub-pack having a third cell group. The system also includes a heat exchanger that is in thermal communication with the battery pack and is configured to cool the battery pack by flow of a liquid coolant from a coolant inlet to a coolant outlet in a flow direction of the liquid coolant, wherein the first cell group, the third cell group, and the second cell group are physically arranged sequentially along the heat exchanger in the flow direction of the liquid coolant with the third cell group located between the first cell group and the second cell group. The system also includes a charging system that is configured to control charging of the first sub-pack so that the liquid coolant, during flow from the coolant inlet to the coolant outlet, absorbs heat from the first cell group of the first sub-pack, supplies heat to the third cell group of the second sub-pack, and absorbs heat from the second cell group of the first sub-pack.

In some implementations of the system according to the second aspect of the disclosure, the charging system controls charging of the first sub-pack such that the second sub-pack is not charged during charging of the first sub-pack. In some implementations of the system according to the second aspect of the disclosure, the charging system controls charging of the first sub-pack such that the first sub-pack is charged at a first charging rate while the second sub-pack is charged at a second charging rate that is lower than the first charging rate. In some implementations of the system according to the second aspect of the disclosure, the first cell group and the second cell group of the first sub-pack are electrically connected in series, and the second sub-pack is not directly electrically connected to the first sub-pack. In some implementations of the system according to the second aspect of the disclosure, the first sub-pack is configured to output electrical power at a first voltage, the second sub-pack is configured to output electrical power at a second voltage that is lower than the first voltage, and the first cell group and the second cell group each include at least five times as many individual cells as the third cell group.

A third aspect of the disclosure is a system that includes a battery pack that extends in a first direction between a first end of the battery pack and a second end of the battery pack, the battery pack having a first sub-pack and a second sub-pack, the first sub-pack having a first cell group and a second cell group, and the second sub-pack having a third cell group, wherein the second sub-pack is not directly electrically connected to the first sub-pack. The system also includes a heat exchanger that is in thermal communication with the battery pack and is configured to cool the battery pack by flow of a liquid coolant from a coolant inlet to a coolant outlet in a flow direction of the liquid coolant, the heat exchanger having a first portion that extends from the first end of the battery pack to the second end of the battery pack, a second portion that extends from the first end of the battery pack to the second end of the battery pack, and an intermediate portion that is located at the second end of the battery pack and extends from the first portion to the second portion. The liquid coolant flows sequentially through the first portion, the intermediate portion, and the second portion during flow from the coolant inlet to the coolant outlet, the first cell group of the first sub-pack is adjacent to the first portion of the heat exchanger, the third cell group of the second sub-pack is adjacent to the first portion of the heat exchanger, and the second cell group of the first sub-pack is adjacent to the second portion of the heat exchanger.

In some implementations of the system according to the third aspect of the disclosure, the first portion of the heat exchanger and the second portion of the heat exchanger are spaced in a second direction that is transverse to the first direction. In some implementations of the system according to the third aspect of the disclosure, the coolant inlet is connected to the first portion of the heat exchanger at the first end of the battery pack, and the coolant outlet is connected to the second portion of the heat exchanger at the first end of the battery pack. In some implementations of the system according to the third aspect of the disclosure, the second sub-pack is located at the second end of the battery pack.

Some implementations of the system according to the third aspect of the disclosure also include a charging system that is configured to control charging of the first sub-pack and the second sub-pack independently, wherein the charging system is configured to control charging of the first sub-pack so that a temperature of the third cell group of the second sub-pack is lower than a temperature of the first cell group of the first sub-pack and lower than a temperature of the second cell group of the first sub-pack.

### BRIEF DESCRIPTION OF THE DRAWINGS

FIG. 1 is a block diagram of a battery system.

FIG. 2 is a side-view schematic illustration of a battery pack, a cooling system, and a heat exchanger according to a first implementation.

FIG. 3 is a side-view schematic illustration of a battery pack, a cooling system, and a heat exchanger according to a second implementation.

FIG. 4 is top-view schematic illustrations of a cooling system and a heat exchanger.

FIG. 5 is top-view schematic illustrations of the cooling system and the heat exchanger of FIG. 4 in combination with a battery pack according to a third implementation.

FIG. 6 is top-view schematic illustrations of the cooling system and the heat exchanger of FIG. 4 in combination with a battery pack according to a fourth implementation.

FIG. 7 is top-view schematic illustrations of the cooling system and the heat exchanger of FIG. 4 in combination with a battery pack according to a fifth implementation.

### DETAILED DESCRIPTION

The disclosure herein relates to cooling a battery pack, for example, during charging of the battery pack. The battery packs described herein include a first sub-pack and a second sub-pack. Charging of the first sub-pack and the second sub-pack may be controlled separately. By charging the first sub-pack while the second sub-pack is not being charged or while the second sub-pack is charging at a lower charging rate as compared to the first sub-pack, the second sub-pack may serve as a heat sink, by absorbing a portion of the heat generated by the first sub-pack. In addition, by placing the second sub-pack, or a portion thereof, between two separate groups of cells from the first sub-pack, a cooling system may absorb heat from a first cell group of the first sub-pack, distribute part of that heat to the second sub-pack, and then subsequently absorb additional heat from a second cell group of the first sub-pack, which may provide for more even absorption of heat from the first sub-pack by the cooling system.

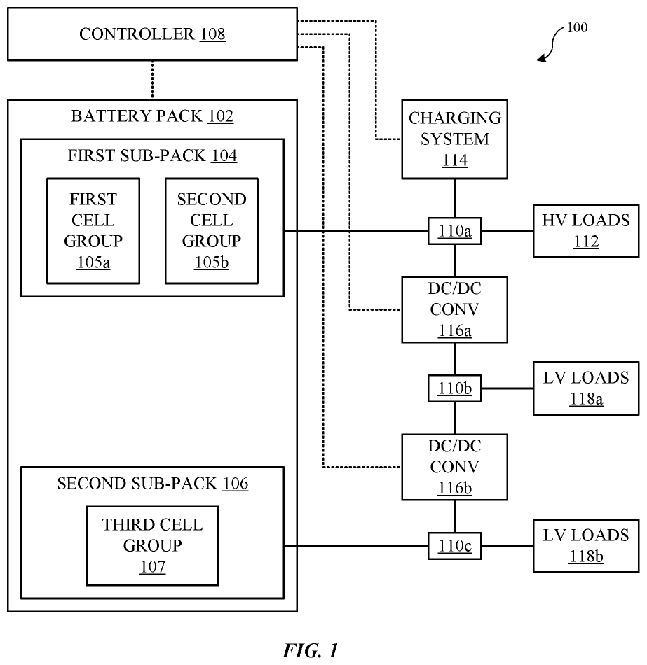

FIG. 1 is a block diagram of a battery system 100. As an example, the battery system 100 may be implemented in the context of an electric vehicle to supply electrical power to some or all of the systems that are included in the electric vehicle. As an example, the electric vehicle may be a conventional road-going vehicle that includes a vehicle body and is supported by wheels. The electric vehicle may be, for example, a car, a truck, a motorcycle, a boat, or an aircraft. The electric vehicle may include a passenger compartment and/or a cargo compartment. The electric vehicle may include systems that perform specific functions, such as a suspension system, a propulsion system, a braking system, a steering system, a sensing system, and a control system (e.g., manual or automated).

The battery system 100 includes a battery pack 102 that has a first sub-pack 104 and a second sub-pack 106. The first sub-pack 104 and the second sub-pack 106 may each include one or more cells groups that each include two or more individual cells. In the illustrated implementation, the first sub-pack 104 has a first cell group 105a and a second cell group 105b, and the second sub-pack 106 has a third cell group 107.

The first cell group 105a and the second cell group 105b of the first sub-pack 104 may be electrically connected in series, and individual cells from the first cell group 105a and the second cell group 105b may also be electrically connected to one another in series. Similarly, individual cells from the third cell group 107 of the second sub-pack 106 may be electrically connected to one another in series. The second sub-pack 106 is not directly electrically connected to the first sub-pack 104. Instead, other components of the battery system 100 allow the first sub-pack 104 and the second sub-pack 106 to be used independently in various ways, and may also allow charging of the second sub-pack 106 using power from the first sub-pack 104, as will be explained. The first sub-pack 104 may be a high-voltage battery pack, and the second sub-pack 106 may be a low-voltage battery pack. Thus, the first sub-pack 104 may be configured to output electrical power at a first voltage, and the second sub-pack 106 may be configured to output electrical power at a second voltage that is lower than the first voltage.

The cells included in the first sub-pack 104 and the cells included in the second sub-pack 106 may be the same type of cells, for example, having a common cell voltage, a common geometric configuration, and a common battery chemistry type. To achieve a higher voltage for the first sub-pack 104 as compared to the second sub-pack 106, the first sub-pack 104 may include a higher number of individual cells as compared to the number of individual cells included in the second sub-pack 106. As an example, the first cell group 105a and the second cell group 105b may each include at least five times as many individual cells as compared to the number of individual cells included in the third cell group 107. Thus, in some implementations, the first sub-pack 104 is configured to output electrical power at a first voltage, the second sub-pack 106 is configured to output electrical power at a second voltage that is lower than the first voltage, and the first cell group 105a and the second cell group 105b each include at least five times as many individual cells as the third cell group 107.

In the illustrated implementation, battery system 100 includes a first bus portion 110a, a second bus portion 110b, and a third bus portion 110c, which are electrical power distribution structures that are configured to distribute power to various components. The first bus portion 110a, the second bus portion 110b, and the third bus portion 110c include conductors and, optionally, other components that control distribution of power to various connected components. The first bus portion 110a is electrically connected to the first sub-pack 104 of the battery pack 102, and operates at a first voltage level V1, which is equal to the voltage level of the first sub-pack 104. A group of high voltage loads 112 may be connected to the first bus portion 110a to receive power at the voltage of the first sub-pack 104. As an example, the group of high voltage loads 112 may include an electric vehicle propulsion system including, for example, an inverter and an electric motor. A charging system 114 may be connected to the first bus portion 110a to supply electrical power to the first bus portion 110a from an external power source for the purpose of charging the first sub-pack 104. As an example, the external power source that provides electrical power to the charging system 114 may be an electric vehicle charging station.

The second bus portion 110b is connected to the first bus portion 110a by a first DC-DC converter 116a and is connected to the third bus portion 110c by a second DC-DC converter 116b. The first DC-DC converter 116a and the second DC-DC converter 116b may be implemented using any suitable converter architecture, such as a switched-type converter architecture (e.g., implemented using transistors). The second bus portion 110b operates at a second voltage V2, which is lower than the first voltage V1 of the first bus portion 110a. The third bus portion 110c operates at a third voltage V3, which is the voltage at which the second sub-pack 106 of the battery pack 102 operates. The third voltage V3 may be the same voltage as the second voltage V2 or may be lower than the second voltage V2.

Connection of the first DC-DC converter 116a to the first bus portion 110a and the second bus portion 110b allows the first DC-DC converter 116a to transfer power between the first bus portion 110a and the second bus portion 110b, while regulating the output voltage of the transferred power and while regulating the amount of power transferred. Connection of the second DC-DC converter 116b to the second bus portion 110b and the third bus portion 110c allows the second DC-DC converter 116b to transfer power between the second bus portion 110b and the third bus portion 110c, while regulating the output voltage of the transferred power and while regulating the amount of power transferred.

A first group of low voltage loads 118a may be connected to the second bus portion 110b, and a second group of low voltage loads 118b may be connected to the third bus portion 110c. Inclusion of the second DC-DC converter 116b allows for separate control of the supply of power to the first group of low voltage loads 118a and to the second group of low voltage loads 118b. In some implementations, the functionality may not be needed, and the second bus portion 110b and the second DC-DC converter 116b may be omitted in favor of connection of the third bus portion 110c to the first bus portion 110a by the first DC-DC converter 116a.

The first sub-pack 104 may be charged by the charging system 114 using electrical power from an external power source. To charge the second sub-pack 106, electrical power may be supplied to the second sub-pack 106 from the first sub-pack 104. This may occur subsequent to charging of the first sub-pack 104 by the charging system 114, for example, while the charging system 114 is not connected to an external power source. Alternatively, in some situations, the first sub-pack 104 and the second sub-pack 106 may be charged concurrently by the charging system 114 using electrical power from the external power source.

The charging system 114 is configured to control charging of the first sub-pack 104 and the second sub-pack 106 independently. The charging system 114 may control whether each of the first sub-pack 104 and the second sub-pack 106 is being charged at a particular time, such as by charging only the first sub-pack 104, charging only the second sub-pack 106, or by charging the first sub-pack 104 and the second sub-pack 106 concurrently. The charging system 114 may also control the charging rate (e.g., in kilowatts) of the first sub-pack 104 and the second sub-pack 106. As an example, when the first sub-pack 104 and the second sub-pack 106 are charged independently, the first sub-pack 104 may be charged at a higher charging rate than the charging rate at which the second sub-pack 106 is charged at. As an example the first sub-pack 104 may be charged at a charging rate that is two times or more than the charging rate of the second sub-pack 106.

By independently controlling charging of the first sub-pack 104 and the second sub-pack 106, the charging system 114 can cause a temperature difference between the first sub-pack 104 and the second sub-pack 106. Thus, the charging system 114 may control charging of the first sub-pack 104 so that a temperature of the third cell group 107 of the second sub-pack 106 is lower than a temperature of the first cell group 105a of the first sub-pack 104 and lower than a temperature of the second cell group 105b of the first sub-pack 104. As an example, to maintain the second sub-pack 106 at a lower temperature than the first sub-pack 104, the charging system 114 can control charging of the first sub-pack 104 and the second sub-pack 106 such that the second sub-pack 106 is not charged during charging of the first sub-pack 104. Thus, while the temperature of the first sub-pack 104 is directly increased by the charging operation, the temperature of the second sub-pack 106 is not concurrently increased by charging in this example, and would instead increase only as a function of heat transfer into the second sub-pack 106 from adjacent, higher-temperature components and/or by discharging of the second sub-pack 106 during charging of the first sub-pack 104.

As another example, to maintain the second sub-pack 106 at a lower temperature than the first sub-pack 104, the charging system 114 can control charging of the first sub-pack 104 such that the first sub-pack 104 is charged at a first charging rate while the second sub-pack 106 is charged at a second charging rate that is lower than the first charging rate. In one implementation, the charging rate of the second sub-pack 106 is a predetermined charging rate that is lower than the charging rate of the first sub-pack 104. In another implementation, the charging rate of the second sub-pack 106 is determined based on the charging rate of the first sub-pack 104, for example, as a percentage of the charging rate of the first sub-pack 104, using a formula based on the charging rate of the first sub-pack 104, or using a lookup table or other information that specifies a relationship between the charging rate of the first sub-pack 104 and the second sub-pack 106.

Operation of the battery pack 102, the charging system 114, the first DC-DC converter 116a, and the second DC-DC converter 116b may be controlled by a controller 108. The controller 108 is configured to operate the various components of the battery system 100, such as by controlling power supply by the components and/or power transfer by the components. The controller 108 may be a computer-implemented system, such as one including a processor, a memory, and instructions that are stored in the memory and configured to cause the processor to perform the functions described herein. Other implementations of the controller 108 are possible, such as implementations using an application specific integrated circuit or a field programmable gate array.

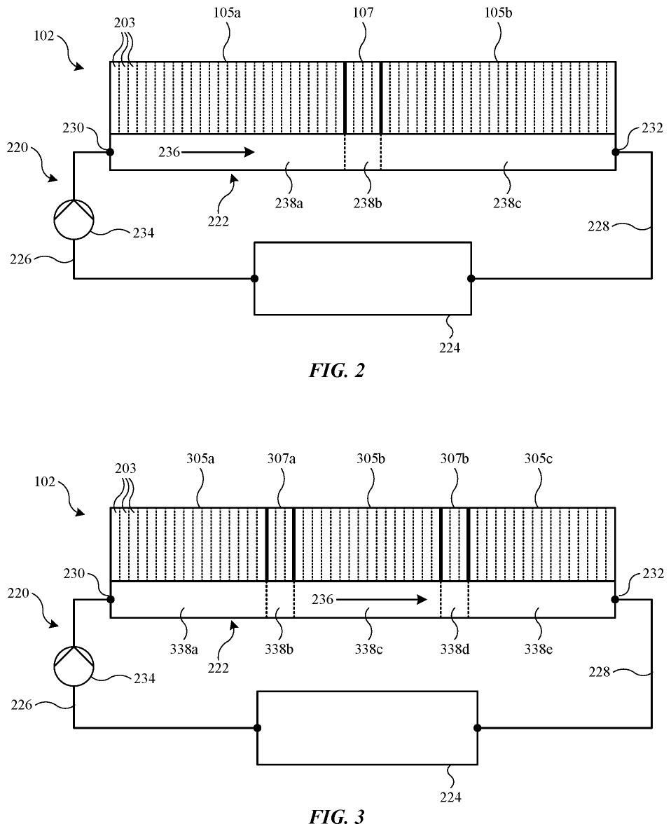

FIG. 2 is a side-view schematic illustration of the battery pack 102 according to a first implementation, a cooling system 220, and a heat exchanger 222. The cooling system 220 is configured to supply a liquid coolant to the heat exchanger 222, and the heat exchanger 222 is configured to absorb heat from the battery pack 102. The battery pack 102 is arranged on the heat exchanger 222 such that the first cell group 105a of the first sub-pack 104 is located at a first end of the heat exchanger 222, the second cell group 105b of the first sub-pack 104 is located at a second end of the heat exchanger 222, and the third cell group 107 of the second sub-pack 106 is located at an intermediate location along the heat exchanger 222 and is physically located between the first cell group 105a and the second cell group 105b. In the illustrated implementation, individual cells 203 from the battery pack 102 have a generally rectangular shape and are positioned in a side-by-side configuration between the first end of the heat exchanger 222 and the second end of the heat exchanger 222.

The cooling system 220 supplies the liquid coolant to the heat exchanger 222 at a lower temperature than that of the battery pack 102, so that the heat exchanger 222 may absorb heat from the battery pack 102 and transfer the heat into the liquid coolant. As an example, the liquid coolant may be ethylene glycol. Other liquid coolants may be used. In the illustrated implementation, the cooling system 220 includes a refrigeration cycle thermal system 224 that is configured to lower a temperature of the liquid coolant. As an example, the refrigeration cycle thermal system 224 may lower the temperature of the liquid coolant by heat exchange between the liquid coolant and a heat-absorbing component of the refrigeration cycle thermal system 224, such as an evaporator.

The refrigeration cycle thermal system 224 is connected to the heat exchanger 222 by a supply line 226 that transports the liquid coolant from the refrigeration cycle thermal system 224 to the heat exchanger 222, and a return line 228 that transports the liquid coolant from the heat exchanger 222 to the refrigeration cycle thermal system 224. The supply line 226 and the return line 228 are conduits or other suitable liquid-carrying structures that are configured to transport the liquid coolant between the heat exchanger 222 and the refrigeration cycle thermal system 224. The supply line 226 extends from the cooling system 220 to the heat exchanger 222, and is connected to a coolant inlet 230 of the heat exchanger 222. The return line 228 extends from the heat exchanger 222 to the cooling system 220, and is connected to a coolant outlet 232 of the heat exchanger 222. The cooling system 220 also includes a pump 234 that is configured to cause circulation of the liquid coolant between the refrigeration cycle thermal system 224 and the heat exchanger 222.

The heat exchanger 222 is in thermal communication with the battery pack 102 and is configured to cool the battery pack 102 by flow of the liquid coolant from a coolant inlet 230 to a coolant outlet 232 in a flow direction 236 of the liquid coolant. To allow transfer of heat between the liquid coolant in the heat exchanger 222 and the battery pack 102, the heat exchanger may be implemented in the form of a housing that is formed from a thermally conductive material and has a hollow interior that is configured to conduct the coolant therethrough between the coolant inlet 230 and the coolant outlet 232. The heat exchanger 222 may include internal structures such as baffles or flow channels that are configured to control flow of the liquid coolant through the heat exchanger 222.

In the illustrated implementation, the coolant inlet 230 is located at the first end of the heat exchanger 222, and the coolant outlet 232 is located at the second end of the heat exchanger 222, with the liquid coolant following the flow direction 236 through the interior of the heat exchanger 222 between the first end of the heat exchanger 222 and the second end of the heat exchanger 222. The heat exchanger 222 includes a first section 238a, a second section 238b, and a third section 238c that are arranged sequentially in a flow direction of the liquid coolant between the coolant inlet 230 and the coolant outlet 232. Thus, the liquid coolant enters the heat exchanger 222 at the coolant inlet 230, then passes through the first section 238a, then passes through the second section 238b, then passes through the third section 238c, and then exits the heat exchanger 222 at the coolant outlet 232.

The first section 238a, the second section 238b, and the third section 238c are defined by their adjacency to different portions of the battery pack 102, which may result in differences in how heat is exchanged between the battery pack 102 and the sections of the heat exchanger 222, as will be explained. In the illustrated implementation, the first cell group 105a of the first sub-pack 104, the third cell group 107 of the second sub-pack 106, and the second cell group 105b of the first sub-pack 104 are physically arranged sequentially along the heat exchanger 222 in the flow direction 236 of the liquid coolant with the third cell group 107 located between the first cell group 105a and the second cell group 105b. These positions correspond to the locations of the sections of the heat exchanger 222. In particular, in the illustrated implementation, the first section 238a of the heat exchanger 222 is positioned adjacent to the first cell group 105a of the first sub-pack 104, the second section 238b of the heat exchanger 222 is downstream from the first section 238a relative to the flow direction 236 and is positioned adjacent to the third cell group 107 of the second sub-pack 106, and the third section 238c of the heat exchanger 222 is downstream from the second section 238b relative to the flow direction 236 and is positioned adjacent to the second cell group 105b of the first sub-pack 104.

As previously described, the charging system 114 may control charging of the first sub-pack 104 and the second sub-pack 106 independently in a manner that results in a temperature difference between the first sub-pack 104 and the second sub-pack 106. The temperature difference between the first sub-pack 104 and the second sub-pack 106 changes the distribution of heat transfer between the heat exchanger 222 and the battery pack 102. Because of this temperature difference, the temperature of the third cell group 107 of the second sub-pack 106 is lower than the temperature of the first cell group 105a and the second cell group 105b.

The lowered temperature of the third cell group 107 relative to the first cell group 105a and the second cell group 105b, in combination with the position of the third cell group 107 between the first cell group 105a and the second cell group 105b allows the third cell group 107 to function as a heat sink, by absorbing some of the heat from the liquid coolant in the heat exchanger 222. Thus, for example, during charging of the first sub-pack 104, the liquid coolant flows from the coolant inlet 230 to the coolant outlet 232 in the flow direction 236 of the liquid coolant, the liquid coolant in the first section 238a of the heat exchanger 222 absorbs heat from the first cell group 105a, and the liquid coolant then passes to the second section 238b of the heat exchanger 222. In the second section 238b of the heat exchanger 222, the third cell group 107 absorbs heat from the liquid coolant. Thus, the temperature of the liquid coolant decreases as it passes through the second section 238b of the heat exchanger 222. The liquid coolant then passes into the third section 238c of the heat exchanger 222, where the liquid coolant absorbs heat from the second cell group 105b of the first sub-pack 104. Stated differently, the charging system 114 controls charging of the first sub-pack 104 and the second sub-pack 106 so that the liquid coolant, during flow from the coolant inlet 230 to the coolant outlet 232, absorbs heat from the first cell group 105a of the first sub-pack 104, supplies heat to the third cell group 107 of the second sub-pack 106, and absorbs heat from the second cell group 105b of the first sub-pack 104.

It should be understood that the first sub-pack 104 and the second sub-pack 106 may include additional cell groups, with each cell group from the second sub-pack 106 being positioned between a pair of cell groups from the first sub-pack 104, so that the cell groups of the second sub-pack are able to absorb heat from the liquid coolant in the heat exchanger 222 during charging of the first sub-pack. As an example, FIG. 3 is a side-view schematic illustration of the battery pack 102, the cooling system 220, and the heat exchanger 222 according to a second implementation of the battery pack 102, in which the first sub-pack 104 of the battery pack 102 includes a first cell group 305a, a second cell group 305b, and a third cell group 305c, and the second sub-pack 106 of the battery pack 102 includes a fourth cell group 307a and a fifth cell group 307b. The battery pack 102, the cooling system 220, and the heat exchanger 222 are as previously described except as stated to the contrary herein.

In this implementation, the fourth cell group 307a of the second sub-pack 106 is located between the first cell group 305a and the second cell group 305b of the first sub-pack 104 relative to the flow direction 236 of the liquid coolant. The fifth cell group 307b of the second sub-pack 106 is located between the second cell group 305b and the third cell group 305c of the first sub-pack 104 relative to the flow direction 236 of the liquid coolant. In correspondence to the cell groups of the battery pack 102, the heat exchanger 222 defines a first section 338a, a second section 338b, a third section 338c, a fourth section 338d and a fifth section 338e that each correspond to a respective one of the cell groups of the battery pack 102. Similar to the previous description, charging of the first sub-pack 104 and the second sub-pack 106 is controlled so that the temperature of the second sub-pack is lower than the temperature of the first sub-pack 104. During flow from the coolant inlet 230 to the coolant outlet 232 of the heat exchanger 222, the liquid coolant absorbs heat from the first cell group 305a, the second cell group 305b, and the third cell group 305c of the first sub-pack 104 while the coolant flows through the first section 338a, the third section 338c, and the fifth section 338e, respectively. Within the second section 338b and the fourth section 338d of the heat exchanger 222, the fourth cell group 307a and the fifth cell group 307b absorb heat from the liquid coolant as it flows through the heat exchanger, thereby distributing some of the heat from the first sub-pack 104 to the second sub-pack 106 and allowing the liquid coolant and the heat exchanger 222 to more evenly and effectively remove heat from the first sub-pack 104.

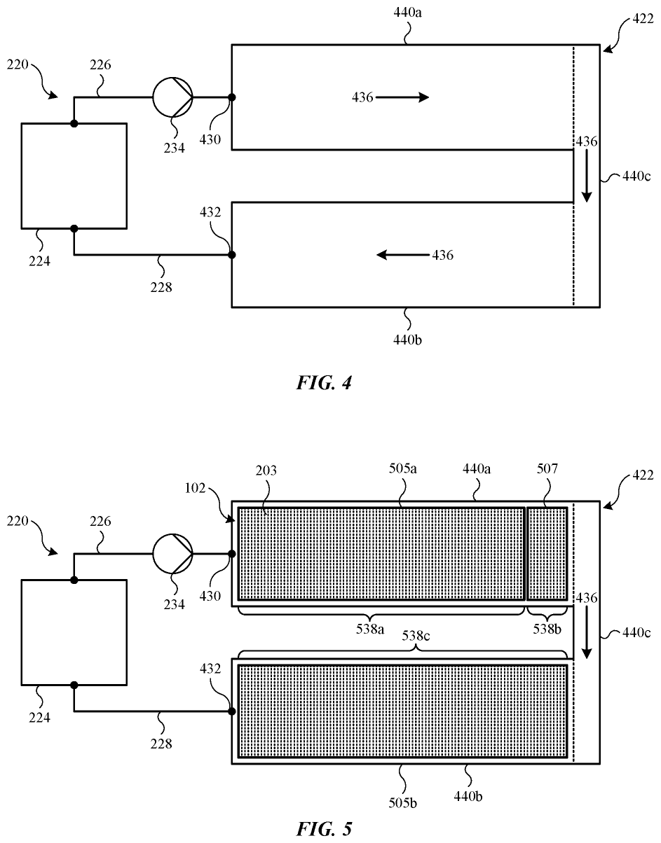

FIG. 4 is a top-view schematic illustration of the cooling system 220 and a heat exchanger 422. The cooling system 220 is as previously described except as stated to the contrary herein. The heat exchanger 422 is equivalent to the heat exchanger 222, and may be implemented in the same manner, except as described to the contrary herein.

The heat exchanger 422 that is in thermal communication with the battery pack 102 and is configured to cool the battery pack 102 by flow of the liquid coolant from a coolant inlet 430 to a coolant outlet 432 in a flow direction 436 of the liquid coolant. As best seen in FIG. 4A, the heat exchanger 422 has a u-shaped configuration as viewed from above, defined by a first portion 440a, an intermediate portion 440b, and a second portion 440c. The coolant inlet 430 is connected to the first portion 440a and is located at a first end of the heat exchanger 422. The coolant outlet 432 is connected to the second portion 440c and is located at the first end of the heat exchanger 422. The intermediate portion 440b is located at the second end of the heat exchanger 422 and interconnects the first portion 440a and the second portion 440c to allow the liquid coolant to flow from the first portion 440a to the second portion 440c. The liquid coolant flows sequentially through the first portion 440a, then through the intermediate portion 440b, and then through the second portion 440c during flow from the coolant inlet 430 to the coolant outlet 432.

The first portion 440a and the second portion 440c of the heat exchanger 422 may both extend in a first direction between the first end and the second end of the heat exchanger 422. The intermediate portion 440b may extend in a second direction that is transverse to the first direction in order to interconnect the first portion 440a and the second portion 440c so that the liquid coolant may flow from the first portion 440a to the second portion 440c. The first portion 440a of the heat exchanger 422 and the second portion 440c of the heat exchanger 422 may be spaced in the second direction.

FIG. 5 is a top-view schematic illustration of the cooling system 220 and the heat exchanger 422 in combination a third implementation of the battery pack 102 in which the first sub-pack 104 includes a first cell group 505a and a second cell group 505b, and the second sub-pack 106 includes a third cell group 507. The battery pack 102 extends between a first end and a second end of the battery pack 102, and is positioned on the heat exchanger 422 so that the first end of the battery pack 102 and the second end of the battery pack 102 correspond to the first end of the heat exchanger 422 and the second end of the heat exchanger 422. The battery pack 102 is as previously described except as stated to the contrary herein.

The first cell group 505a of the first sub-pack 104 is located on and positioned adjacent to the first portion 440a of the heat exchanger 422, and is positioned such that it extends from the first end of the heat exchanger 422 toward the second end of the heat exchanger 422. The area of the heat exchanger 422 adjacent to the first cell group 505a is referred to herein as a first section 538a of the heat exchanger 422, and represents the area of the heat exchanger 422 in which heat exchange occurs between the first cell group 505a and the liquid coolant in the heat exchanger 422.

The third cell group 507 of the second sub-pack 106 is located on and positioned adjacent to the first portion 440a of the heat exchanger 422 at the second end of the battery pack 102, positioned such that it extends from the first cell group 505a toward the second end of the heat exchanger 422, terminating at or adjacent to the intermediate portion 440b of the heat exchanger 422. The area of the heat exchanger 422 adjacent to the third cell group 507 is referred to herein as a second section 538b of the heat exchanger 422, and represents the area of the heat exchanger 422 in which heat exchange occurs between the third cell group 507 and the liquid coolant in the heat exchanger 422.

The second cell group 505b of the first sub-pack 104 is located on and positioned adjacent to the second portion 440c of the heat exchanger 422, and is positioned such that it extends between the first end of the heat exchanger 422 and the second end of the heat exchanger 422. The area of the heat exchanger 422 adjacent to the second cell group 505b is referred to herein as a third section 538c of the heat exchanger 422, and represents the area of the heat exchanger 422 in which heat exchange occurs between the second cell group 505b and the liquid coolant in the heat exchanger 422.

Relative to the battery pack 102, the first portion 440a of the heat exchanger 422 extends from the first end of the battery pack 102 to the second end of the battery pack 102, the second portion 440c of the heat exchanger 422 extends from the first end of the battery pack 102 to the second end of the battery pack 102, and the intermediate portion 440b of the heat exchanger 422 is located at the second end of the battery pack 102 and extends from the first portion 440a to the second portion 440c of the heat exchanger 422.

The liquid coolant flows sequentially through the first portion 440a, the intermediate portion 440b, and the second portion 440c during flow from the coolant inlet 430 to the coolant outlet 432. This causes the liquid coolant to flow sequentially from the coolant inlet 430 into the first section 538a of the heat exchanger 422, then into the second section 538b of the heat exchanger 422, then into the third section 538c of the heat exchanger 422, and then to the coolant outlet 432. During flow through the first section 538a, the liquid coolant absorbs heat from the first cell group 505a, the heat having been generated at least in part by charging of the first cell group 505a. During flow through the second section 538b, the liquid coolant transfers heat to the third cell group 507, so that part of the heat from the liquid coolant is absorbed by the third cell group 507, thereby reducing the temperature of the liquid coolant as it flows through the second section 538b. The third cell group 507 is able to absorb heat because it is maintained at a lower temperature than the first cell group 505a and the second cell group 505b by the charging system 114, as previously described. During flow through the third section 538c, the liquid coolant absorbs heat from the second cell group 505b, the heat having been generated at least in part by charging of the second cell group 505b. In addition, when the coolant travels through the intermediate portion 440b, the flow direction changes upon entry into and exit out of the intermediate portion 440b, optionally combined with a change in cross-sectional shape relative to the first portion 440a and the second portion 440c, which causes turbulence and/or mixing of the liquid coolant, which increases temperature consistency of the liquid coolant as it passes through the intermediate portion 440b.

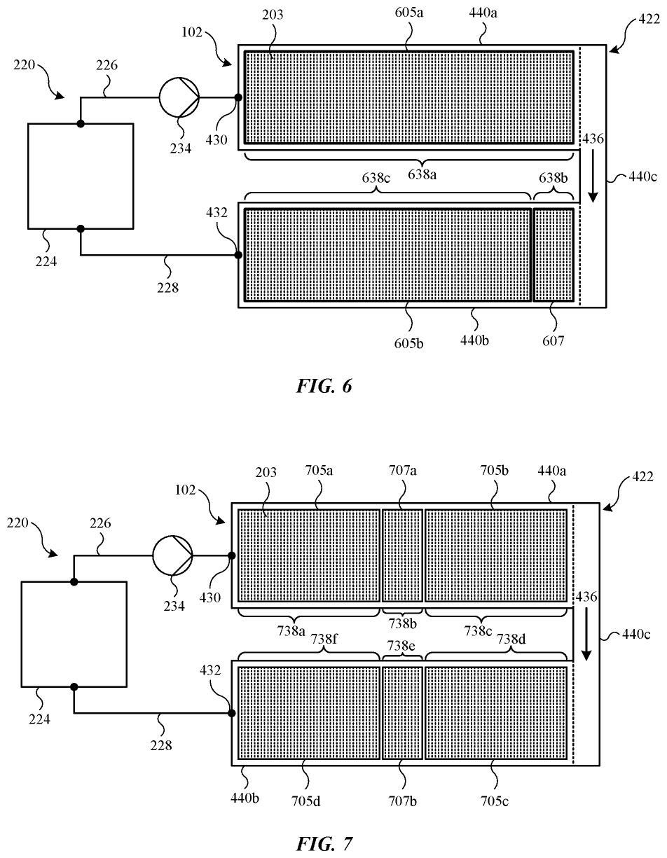

FIG. 6 is a top-view schematic illustration of the cooling system 220 and the heat exchanger 422 in combination a fourth implementation of the battery pack 102 in which the first sub-pack 104 includes a first cell group 605a and a second cell group 605b, and the second sub-pack 106 includes a third cell group 607. The implementation shown in FIG. 6 is equivalent to the implementation shown in FIG. 5 except as described herein.

The first cell group 605a is located on and adjacent to the first portion 440a, and extends from the first end to the second end of the battery pack 102. A first section 638a of the heat exchanger 422 is defined in the first portion 440a adjacent to the first cell group 605a. The third cell group 607 is located on and adjacent to the second portion 440c at the second end of the battery pack 102 adjacent to the intermediate portion 440b. The third cell group 607 extends from the second end of the battery pack 102 to the second cell group 605b of the first sub-pack 104, which in turn extends to the first end of the heat exchanger 422 on the second portion 440c of the heat exchanger 422. A second section 638b of the heat exchanger 422 is defined in the second portion 440c adjacent to the third cell group 607, and a third section 638c of the heat exchanger 422 is defined in the second portion 440c adjacent to the second cell group 605b. During flow of the liquid coolant through the heat exchanger 422 from the coolant inlet 430 to the coolant outlet 432, the liquid coolant absorbs heat from the first cell group 605a in the first section 638a, heat is absorbed from the liquid coolant by the third cell group 607 in the second section 638b, and the liquid coolant absorbs heat from the second cell group 605b in the third section 638c.

FIG. 7 is a top-view schematic illustration of the cooling system 220 and the heat exchanger 422 in combination a fifth implementation of the battery pack 102 in which the first sub-pack 104 includes a first cell group 705a, a second cell group 705b, a third cell group 705c, and a fourth cell group 705d, and the second sub-pack 106 includes a fifth cell group 707a and a sixth cell group 707b. The implementation shown in FIG. 7 is equivalent to the implementation shown in FIG. 5 except as described herein.

The first cell group 705a, the second cell group 705b, and the fifth cell group 707a are located on and adjacent to the first portion 440a, with the first cell group 705a at the first end, the second cell group 705b at the second end, and the fifth cell group 707a positioned between the first cell group 705a and the second cell group 705b. The third cell group 705c, the fourth cell group 705d, and the sixth cell group 707b are located on and adjacent to the second portion 440c, with the third cell group 705c at the second end, the fourth cell group 705d at the second end, and the sixth cell group 707b positioned between the third cell group 705c and the fourth cell group 705d. During flow of the liquid coolant through the heat exchanger 422 from the coolant inlet 430 to the coolant outlet 432, the liquid coolant absorbs heat from the first cell group 705a in a first section 738a, heat is absorbed from the liquid coolant by the fifth cell group 707a in a second section 738b, and the liquid coolant absorbs heat from the second cell group 705b in a third section 738c. The liquid coolant then passes from the first portion 440a to the second portion 440c through the intermediate portion 440b. In the second portion 440c of the heat exchanger 422, the liquid coolant absorbs heat from the third cell group 705c in a fourth section 738d, heat is absorbed from the liquid coolant by the sixth cell group 707b in a fifth section 738e, and the liquid coolant absorbs heat from the fourth cell group 705d in a sixth section 738f. The liquid coolant then passes from the second portion 440c through the coolant outlet 432.

As described above, one aspect of the present technology is the gathering and use of data available from various sources for use during operation of a system, such as a vehicle, that includes the battery pack and cooling system described herein. As an example, such data may identify the user and include user-specific settings or preferences. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, a user profile may be established that stores user preferences to allow customized operation. Accordingly, use of such personal information data enhances the user's experience.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide data regarding usage of specific applications. In yet another example, users can select to limit the length of time that application usage data is maintained or entirely prohibit the development of an application usage profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, needed information may be determined each time the system is used, and without subsequently storing the information or associating with the particular user.

What is claimed is:

1. A system, comprising:
a battery pack having a first sub-pack and a second sub-pack, the first sub-pack having a first cell group and a second cell group, and the second sub-pack having a third cell group;
a cooling system that is configured to supply a liquid coolant; and
a heat exchanger that is in thermal communication with the battery pack, the heat exchanger including a coolant inlet, a coolant outlet, a first section, a second section, and a third section that are physically arranged sequentially in a flow direction of the liquid coolant between the coolant inlet and the coolant outlet,
wherein the first section of the heat exchanger is positioned adjacent to the first cell group of the first sub-pack, the second section of the heat exchanger is positioned adjacent to the third cell group of the second sub-pack, and the third section of the heat exchanger is positioned adjacent to the second cell group of the first sub-pack.

2. The system of claim 1, further comprising:
a charging system that is configured to control charging of the first sub-pack and the second sub-pack independently.

3. The system of claim 2, wherein the charging system is configured to control charging of the first sub-pack so that a temperature of the third cell group of the second sub-pack is lower than a temperature of the first cell group of the first sub-pack and lower than a temperature of the second cell group of the first sub-pack.

4. The system of claim 3, wherein, during charging of the first sub-pack, the liquid coolant flows from the coolant inlet to the coolant outlet in the flow direction of the liquid coolant, the liquid coolant in the first section of the heat exchanger absorbs heat from the first cell group, the third cell group absorbs heat from the liquid coolant in the second section of the heat exchanger, and the liquid coolant in the third section of the heat exchanger absorbs heat from the second cell group.

5. The system of claim 3, wherein the charging system controls charging of the first sub-pack such that the second sub-pack is not charged during charging of the first sub-pack.

6. The system of claim 3, wherein the charging system controls charging of the first sub-pack such that the first sub-pack is charged at a first charging rate while the second sub-pack is charged at a second charging rate that is lower than the first charging rate.

7. The system of claim 1, wherein the first cell group and the second cell group of the first sub-pack are electrically connected in series, and the second sub-pack is not directly electrically connected to the first sub-pack.

8. The system of claim 1, wherein the first sub-pack is configured to output electrical power at a first voltage, the second sub-pack is configured to output electrical power at a second voltage that is lower than the first voltage.

9. The system of claim 1, wherein the first cell group and the second cell group each include at least five times as many individual cells as the third cell group.

10. The system of claim 1, wherein the cooling system includes a refrigeration cycle thermal system that is configured to lower a temperature of the liquid coolant.

11. A system, comprising:
a battery pack having a first sub-pack and a second sub-pack, the first sub-pack having a first cell group and a second cell group, and the second sub-pack having a third cell group;
a heat exchanger that is in thermal communication with the battery pack and is configured to cool the battery pack by flow of a liquid coolant from a coolant inlet to a coolant outlet in a flow direction of the liquid coolant, wherein the first cell group, the third cell group, and the second cell group are physically arranged sequentially along the heat exchanger in the flow direction of the liquid coolant with the third cell group located between the first cell group and the second cell group; and
a charging system that is configured to control charging of the first sub-pack so that the liquid coolant, during flow from the coolant inlet to the coolant outlet, absorbs heat from the first cell group of the first sub-pack, supplies heat to the third cell group of the second sub-pack, and absorbs heat from the second cell group of the first sub-pack.

12. The system of claim 11, wherein the charging system controls charging of the first sub-pack such that the second sub-pack is not charged during charging of the first sub-pack.

13. The system of claim 11, wherein the charging system controls charging of the first sub-pack such that the first sub-pack is charged at a first charging rate while the second sub-pack is charged at a second charging rate that is lower than the first charging rate.

14. The system of claim 11, wherein the first cell group and the second cell group of the first sub-pack are electrically connected in series, and the second sub-pack is not directly electrically connected to the first sub-pack.

15. The system of claim 11, wherein the first sub-pack is configured to output electrical power at a first voltage, the second sub-pack is configured to output electrical power at a second voltage that is lower than the first voltage, and the first cell group and the second cell group each include at least five times as many individual cells as the third cell group.

16. A system, comprising:
a battery pack that extends in a first direction between a first end of the battery pack and a second end of the battery pack, the battery pack having a first sub-pack and a second sub-pack, the first sub-pack having a first cell group and a second cell group, and the second sub-pack having a third cell group, wherein the second sub-pack is not directly electrically connected to the first sub-pack; and
a heat exchanger that is in thermal communication with the battery pack and is configured to cool the battery pack by flow of a liquid coolant from a coolant inlet to a coolant outlet in a flow direction of the liquid coolant, the heat exchanger having a first portion that extends from the first end of the battery pack to the second end of the battery pack, a second portion that extends from the first end of the battery pack to the second end of the battery pack, and an intermediate portion that is located at the second end of the battery pack and extends from the first portion to the second portion,
wherein the liquid coolant flows sequentially through the first portion, the intermediate portion, and the second portion during flow from the coolant inlet to the coolant outlet, the first cell group of the first sub-pack is adjacent to the first portion of the heat exchanger, the third cell group of the second sub-pack is adjacent to the first portion of the heat exchanger, and the second cell group of the first sub-pack is adjacent to the second portion of the heat exchanger.

17. The system of claim 16, wherein the first portion of the heat exchanger and the second portion of the heat exchanger are spaced in a second direction that is transverse to the first direction.

18. The system of claim 16, wherein the coolant inlet is connected to the first portion of the heat exchanger at the first end of the battery pack, and the coolant outlet is connected to the second portion of the heat exchanger at the first end of the battery pack.

19. The system of claim 16, wherein the third cell group of the second sub-pack is located at the second end of the battery pack.

20. The system of claim 16, further comprising:
a charging system that is configured to control charging of the first sub-pack and the second sub-pack independently, wherein the charging system is configured to control charging of the first sub-pack so that a temperature of the third cell group of the second sub-pack is lower than a temperature of the first cell group of the first sub-pack and lower than a temperature of the second cell group of the first sub-pack.
